(19) United States
(12) Patent Application Publication
(10) Pub. No.: US 2026/0233396 A1
(43) Pub. Date: Aug. 13, 2026

(54) ROBOT PROGRAMMING DEVICE, ROBOT PROGRAMMING METHOD, AND PROGRAM

(71) Applicant: FANUC CORPORATION, Yamanashi (JP)

(72) Inventor: Hiroyuki YONEYAMA, Yamanashi (JP)

(21) Appl. No.: 19/160,030

(22) PCT Filed: Apr. 26, 2023
(86) PCT No.: PCT/JP2023/016470

§ 371 Date: Aug. 27, 2025

(51) Int. Cl. B25J 9/16

(52) U.S. Cl. CPC B25J 9/1671

(57) ABSTRACT

This robot programming device comprises: a three-dimensional model disposition unit for disposing a robot model, a tool model, and a work model in a virtual space; a biting-depth designation unit for receiving designation of a tolerance for the biting depth of the tool model with respect to the work model; and a teaching-point position-posture adjustment unit for adjusting a position posture of the tool model at a teaching point of the robot program so that the tool model contacts the work model in a state in which the biting depth of the tool model with respect to the work model is equal to the tolerance or less.

### FIELD

The present disclosure relates to a robot programming device, a robot programming method, and a program.

### BACKGROUND

A robot programming device configured to arrange a robot model, a tool model, a workpiece model, and the like in a virtual space and teach an operation to the robot model is known. For example, PTL 1 describes an off-line programming device having a function of creating a machining path of a tool by projecting an operation pattern on a surface of a workpiece model. PTLs 2 and 3 each describe a robot programming device having a function of specifying a machining line on a workpiece model.

### CITATION LIST

### Patent Literature

[PTL 1] Japanese Unexamined Patent Publication (Kokai) No. 2013-248677 A

[PTL 2] Japanese Unexamined Patent Publication (Kokai) No. 2017-140684 A

[PTL 3] Japanese Unexamined Patent Publication (Kokai) No. 2019-48358 A

### SUMMARY

### Technical Problem

When performing the teaching using a robot programming device in regard to, for example, machining in which a surface of a tool is positioned to contact a surface of a workpiece, such as polishing machining, adjustment for bringing the surface of the tool into contact with the workpiece at a suitable posture at each of teaching points generated on the workpiece is required. Such adjustment is sophisticated adjustment requiring a high level of skill and technical knowledge on the part of an operator. A technique enabling automatic adjustment for optimizing the position and the posture of a tool model relative to a workpiece model in teaching using a robot programming device is desired.

### Solution to Problem

An embodiment of the present disclosure is a robot programming device including a three-dimensional model arrangement unit configured to arrange a robot model, a tool model, and a workpiece model in a virtual space; a penetration depth specification unit configured to accept specification of an allowable value of a penetration depth of the tool model relative to the workpiece model; and a teaching point position-posture adjustment unit configured to adjust a position and posture of the tool model at a teaching point in a robot program in such a way that the tool model comes into contact with the workpiece model in a state of the penetration depth of the tool model relative to the workpiece model being equal to or less than the allowable value.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating an external appearance of a robot programming device according to an embodiment.

FIG. 2 is a functional block diagram of the robot programming device.

FIG. 3 is a flowchart illustrating a robot program creation processing executed on the robot programming device.

FIG. 4 is a diagram illustrating a situation where a robot model, a tool model, and a workpiece model are arranged in a virtual space.

FIG. 5 is a diagram illustrating examples of an operation pattern stored in a storage unit.

FIG. 6 is a diagram illustrating examples of a three-dimensional shape stored in the storage unit.

FIG. 7 is a diagram illustrating a situation where a three-dimensional shape is arranged in the virtual space in such a way that an operation pattern is projected on at least one surface of the workpiece model.

FIG. 8 is a diagram illustrating a situation where a machining path of a tool is generated by projecting the operation pattern on at least one surface of the workpiece model.

FIG. 9 is a diagram illustrating a situation where the position and posture of the tool model relative to the workpiece model are determined.

FIG. 10A is a diagram illustrating a situation where a contact region is specified on the tool model.

FIG. 10B is a diagram illustrating a situation where the position and posture of a teaching point in the robot program are adjusted in such a way that the specified contact region is always in contact with the workpiece model.

FIG. 11 is a diagram illustrating a situation where the tool model is translated or rotated in such a way that the tool model is always in contact with the workpiece model at a maximum penetration depth or less.

FIG. 12 is a diagram illustrating a situation where the tool model is translated or rotated in such a way that the contact area between the tool model and the workpiece model is maximized. FIG. 13 is a diagram illustrating a situation where upper and lower limits of an offset amount are set in adjustment of the position and posture of the tool model.

FIG. 14 is a diagram illustrating a situation where restriction on an offset direction is specified in adjustment of the position and posture of the tool model.

FIG. 15 is a flowchart illustrating robot program creation processing related to a machining line.

FIG. 16 is a diagram illustrating a situation where a robot model, a tool model, and a workpiece model are arranged in a virtual space.

FIG. 17 is a diagram illustrating a situation where a machining line is specified on the workpiece model.

FIG. 18 is a diagram illustrating a situation where the position and posture of the tool model are set on the workpiece model.

FIG. 19A is a diagram illustrating a situation where a contact region is specified on the tool model.

FIG. 19B is a diagram illustrating a situation where the position and posture of a teaching point in the robot program are adjusted in such a way that the specified contact region is always in contact with the workpiece model.

FIG. 20 is a diagram illustrating a situation where the tool model is translated or rotated in such a way that the tool model is always in contact with the workpiece model at a maximum penetration depth or less.

FIG. 21 is a diagram illustrating a situation where the tool model is translated or rotated in such a way that the contact area between the tool model and the workpiece model is maximized.

FIG. 22 is a diagram illustrating a situation where upper and lower limits of an offset amount are set in adjustment of the position and posture of the tool model.

FIG. 23 is a diagram illustrating a situation where restriction on an offset direction is specified in adjustment of the position and posture of the tool model.

### DESCRIPTION OF EMBODIMENTS

Next, an embodiment of the present disclosure will be described with reference to the drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

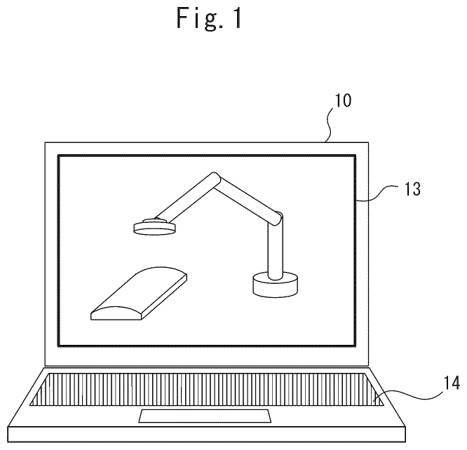

FIG. 1 is a diagram illustrating an external appearance of robot programming device 10 according to an embodiment. Robot programming device 10 is a device enabling arrangement of a robot model, a tool model, a workpiece model, and the like in a virtual space and teaching (programming) of a robot program in the virtual space. As will be described in detail below, robot programming device 10 according to the present embodiment provides a function of optimizing a contact state between the tool model and the workpiece model at a teaching point in the robot program.

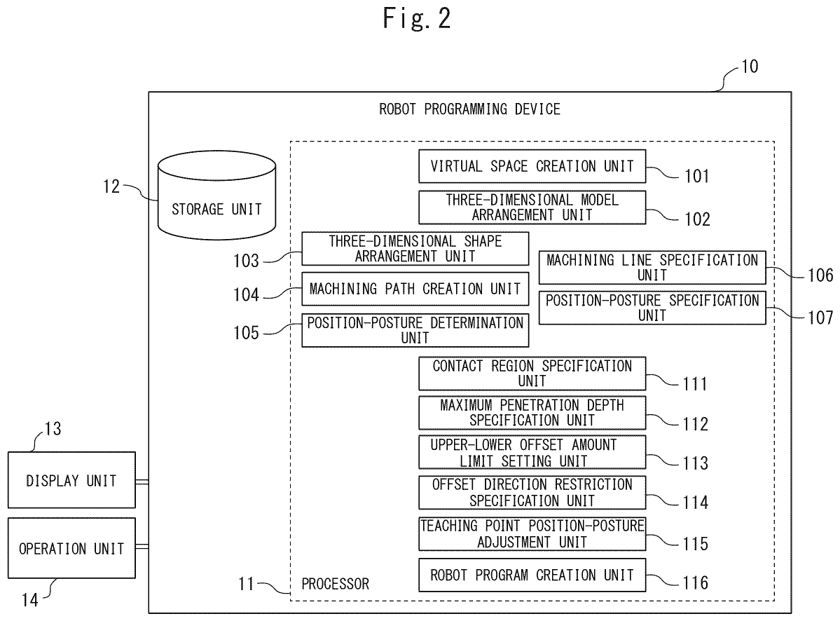

Robot programming device 10 may be constituted of a personal computer (PC), a tablet computer, or any of various other information processing devices. Robot programming device 10 may have a hardware configuration as a common computer including processor 11, a memory (e.g., a ROM, a RAM, or a nonvolatile memory), storage unit 12, display unit 13, operation unit 14, an input-output interface, a network interface, and the like (see FIG. 1 and FIG. 2). For example, storage unit 12 may be constituted of a nonvolatile memory or a hard disk drive. For example, display unit 13 may include a liquid crystal display. Operation unit 14 may include a keyboard, a mouse, and various other input devices.

FIG. 2 is a functional block diagram of robot programming device 10. As illustrated in FIG. 2, robot programming device 10 includes virtual space creation unit 101, three-dimensional model arrangement unit 102, three-dimensional shape arrangement unit 103, machining path creation unit 104, position-posture determination unit 105, machining line specification unit 106, position-posture specification unit 107, contact region specification unit 111, maximum penetration depth specification unit 112, upper-lower offset amount limit setting unit 113, offset direction restriction specification unit 114, teaching point position-posture adjustment unit 115, and robot program creation unit 116. The functional blocks may be provided by execution of software by processor 11 in robot programming device 10. FIG. 2 illustrates storage unit 12. Three-dimensional model data of various objects, operation patterns, three-dimensional shapes, various types of setting information related to teaching, a robot program, and the like are stored in storage unit 12.

Virtual space creation unit 101 provides a function of creating a virtual space on robot programming device 10. Three-dimensional model arrangement unit 102 provides a function of arranging three-dimensional models of objects constituting a robot system model, such as a robot model, a tool model, and a workpiece model, in the virtual space.

Three-dimensional shape arrangement unit 103 provides a function of filling a surface of a predetermined three-dimensional shape with a predetermined operation pattern and arranging the three-dimensional shape in the virtual space in such a way that the operation pattern is projected on at least one surface of the workpiece model. Machining path creation unit 104 provides a function of creating a machining path by projecting, onto at least one surface of the workpiece model, the operation pattern on the three-dimensional shape. Position-posture determination unit 105 provides a function of automatically determining the position or the position and posture of the tool model, based on the created machining path and the normal direction of at least one surface of the workpiece model.

Machining line specification unit 106 provides a function of specifying a machining line as a machining target part on the workpiece model. Position-posture specification unit 107 provides a function for specifying the position or the position and posture of the tool model relative to the specified machining line.

Contact region specification unit 111, maximum penetration depth specification unit 112, upper-lower offset amount limit setting unit 113, offset direction restriction specification unit 114, and teaching point position-posture adjustment unit 115 relate to a function for optimizing the contact state of the tool model relative to the workpiece model. Contact region specification unit 111 provides a function for setting, on the tool model, a contact region with respect to the workpiece model. For example, contact region specification unit 111 may be configured to accept user input or input from an external device for specifying, on the tool model, a contact region with respect to the workpiece model. Maximum penetration depth specification unit 112 provides a function for setting a maximum penetration depth of the tool model relative to the workpiece model. For example, maximum penetration depth specification unit 112 may be configured to accept user input or input from an external device for specifying the maximum penetration depth.

Upper-lower offset amount limit setting unit 113 provides a function for setting upper and lower limits of an offset amount when the position and posture of the tool model at a teaching point in the robot program are adjusted. For example, upper-lower offset amount limit setting unit 113 may be configured to accept user input or input from an external device for specifying upper and lower limits of an offset amount. Offset direction restriction specification unit 114 provides a function for restricting a direction in which an offset amount is added when the position and posture of the tool model at a teaching point in the robot program are adjusted. For example, offset direction restriction specification unit 114 may be configured to accept user input or input from an external device for specifying a direction in which an offset is restricted.

Teaching point position-posture adjustment unit 115 provides a function of adjusting the position and posture of the tool model at a teaching point in the robot program in such a way that the tool model comes into contact with the workpiece model during machining work. It should be noted that, as used herein, the expression “adjusting a position and posture” includes a case of adjusting both a position and a posture, a case of adjusting only a position, and adjusting only a posture. For example, teaching point position-posture adjustment unit 115 has a function of adjusting the position and posture of the tool model at a teaching point in the robot program in such a way that one or more of a condition specified by contact region specification unit 111, a condition specified by maximum penetration depth specification unit 112, a condition specified by upper-lower offset amount limit setting unit 113, a condition specified by offset direction restriction specification unit 114, and a condition that the contact area between the tool model and the workpiece model is maximized are satisfied and the tool model comes into contact with the workpiece model during machining work.

Robot program creation unit 116 provides a function of creating a robot program in accordance with teaching information adjusted by the teaching point position-posture adjustment unit 115.

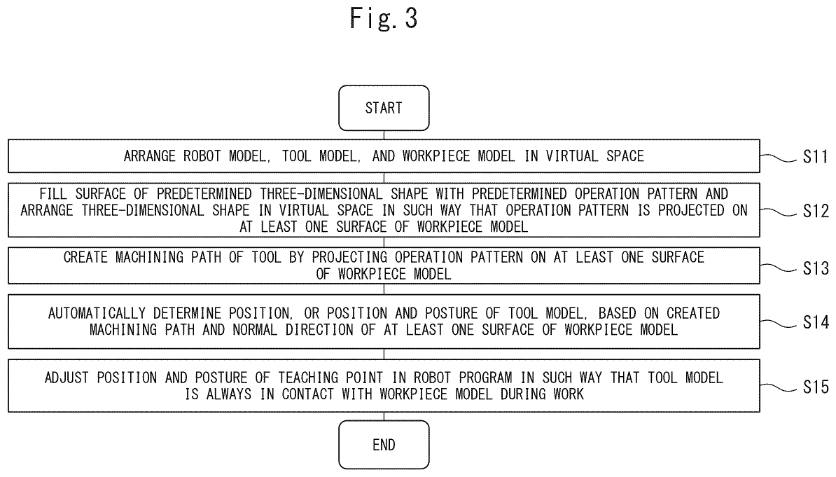

FIG. 3 is a flowchart illustrating robot program creation processing executed on robot programming device 10. The robot program creation processing is executed under the control of processor 11. This operation example relates to processing for creating a robot program for machining in which a tool is positioned to contact a surface of a workpiece, such as polishing machining. A model of an almost disk-shaped grinder is used as a tool model. As will be described in detail below, the robot program creation processing includes a function of optimizing the position and posture of the tool model relative to the workpiece model. The robot program creation processing will be described with reference to FIG. 3 to FIG. 14.

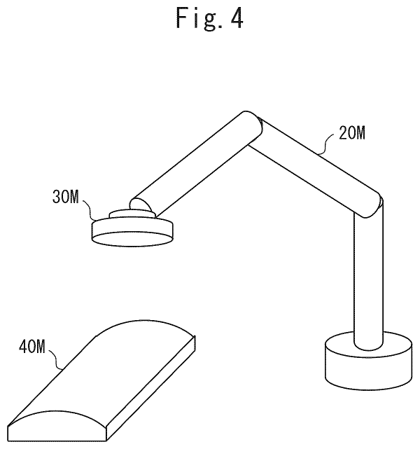

First, virtual space creation unit 101 generates a virtual space on robot programming device 10. The virtual space corresponds to an actual workspace in which a robot and a workpiece are arranged. Then, three-dimensional model arrangement unit 102 arranges a model of a robot system including a robot model, a tool model, and a workpiece model in the virtual space (step S11). FIG. 4 illustrates a situation where robot model 20M, tool model 30M and workpiece model 40M are arranged in the virtual space by the processing in step S11.

Next, in step S12, three-dimensional shape arrangement unit 103 fills a surface of a predetermined three-dimensional shape with a predetermined operation pattern and arranges the three-dimensional shape in the virtual space in such a way that the operation pattern is projected on at least one surface of workpiece model 40M.

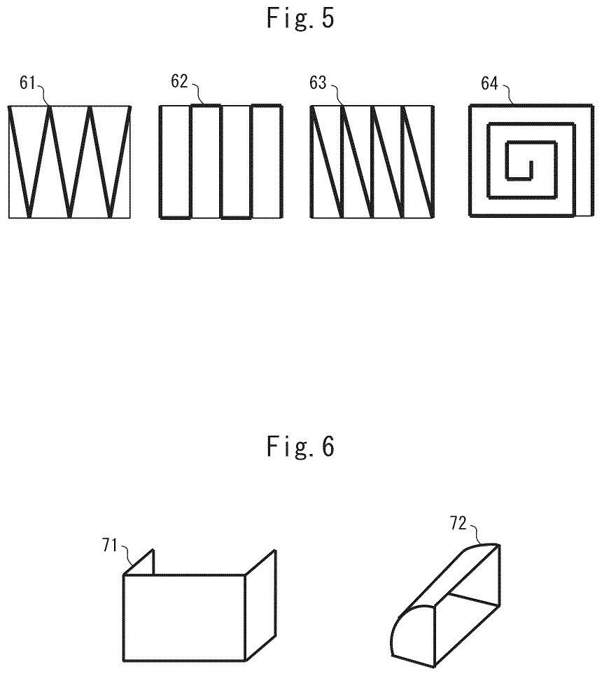

Storage unit 12 stores a plurality of operation patterns indicating operations of a tool. FIG. 5 is a diagram illustrating examples of the operation patterns stored in storage unit 12. As illustrated in FIG. 5, an operation pattern is a continuous trajectory indicating a periodic operation of a tool. For example, an operation pattern includes a uniform-velocity movement in one direction accompanying repetition of a reciprocating motion in another direction almost perpendicular to the one direction. FIG. 5 illustrates examples of operation patterns 61, 62, 63, and 64 that are almost V-shaped, almost U-shaped, almost N-shaped, and almost spiral, respectively. An operation pattern in another shape may be employed as long as the operation pattern causes a tool to move in one direction while causing the tool to reciprocate in a direction mostly perpendicular to the one direction. Three-dimensional shape arrangement unit 103 may have a function of accepting a user operation of selecting one operation pattern from a plurality of operation patterns stored in storage unit 12.

Storage unit 12 stores a plurality of types of three-dimensional shapes. FIG. 6 illustrates examples of the three-dimensional shapes stored in storage unit 12. In the examples illustrated in FIG. 6, storage unit 12 stores three-dimensional shape 71 including a plurality of continuous flat surfaces and three-dimensional shape 72 including a curved surface. It should be noted that while three-dimensional shape 71 includes three continuous flat surfaces, three-dimensional shape 71 may include only two continuous flat surfaces. While the flat surfaces of three-dimensional shape 71 adjacent to each other form a right angle, the flat surfaces may form an angle different from a right angle. In FIG. 6, three-dimensional shape 72 forms part of the circumferential surface of a cylinder and includes a fan-shaped end face. In FIG. 6, the central angle of the fan-shaped end face is 90°. Three-dimensional shape 72 may include a curved surface different from the circumferential surface of a cylinder.

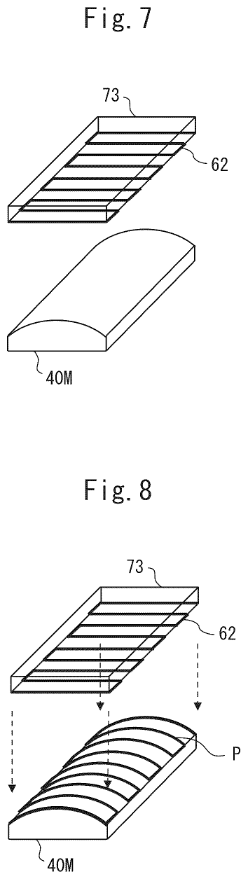

In step S12, an operator selects one operation pattern from the plurality of operation patterns stored in storage unit 12. Furthermore, the operator selects one three-dimensional shape from the plurality of three-dimensional shapes stored in storage unit 12. When a three-dimensional shape is selected, three-dimensional shape arrangement unit 103 fills a curved surface or at least one of a plurality of continuous flat surfaces of the selected three-dimensional shape with the selected operation pattern. Then, as illustrated in FIG. 7, three-dimensional shape arrangement unit 103 arranges the three-dimensional shape in the virtual space in such a way that the operation pattern is projected on at least one surface of workpiece model 40M. It should be noted that FIG. 7 illustrates, as an example, a situation where three-dimensional shape 73 filled with the operation pattern 62 is arranged in the virtual space.

Next, as illustrated in FIG. 8, machining path creation unit 104 generates a machining path of the tool by projecting the operation pattern on at least one surface of workpiece model 40M (step S13). FIG. 8 illustrates, as an example, a situation where operation pattern 62 added to three-dimensional shape 73 is projected on workpiece model 40M. Consequently, machining path P is created on a curved machining surface on workpiece model 40M.

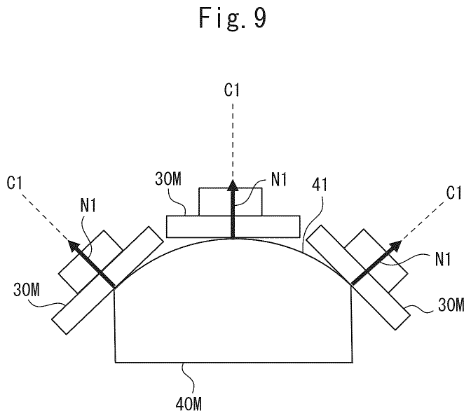

Next, in step S14, processing of automatically determining the position or the position and posture of tool model 130M is performed on the machining path generated as described above. Position-posture determination unit 105 automatically determines the position or the position and posture of tool model 30M, based on created machining path P and the normal direction of machining surface 41 of workpiece model 40M. For example, position-posture determination unit 105 may determine the position and posture of tool model 30M in such a way that normal direction N1 of machining surface 41 of workpiece model 40M on the machining path matches center line (rotation axis) C1 of tool model 30M, as illustrated in FIG. 9.

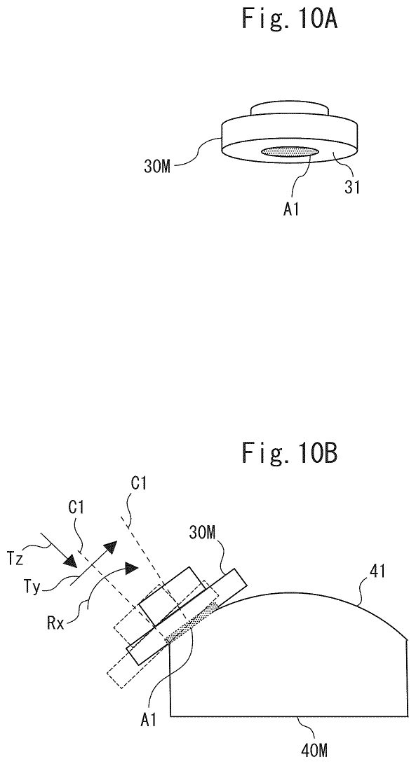

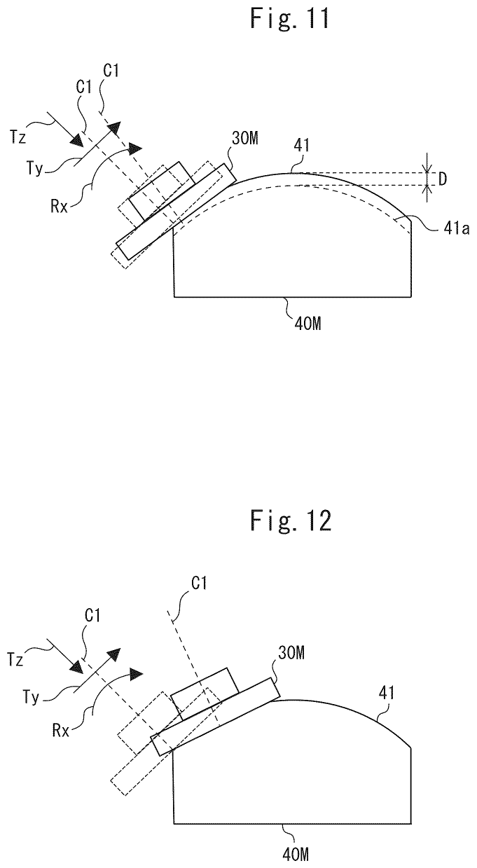

Next, in step S15, processing for adjusting the position and posture of a teaching point is performed by teaching point position-posture adjustment unit 115. It should be noted that the expression “the position and posture of a teaching point” represents the position and posture of the tool at each teaching point defined as a machining path. Teaching point position-posture adjustment unit 115 can prevent tool model 30M from excessively shaving workpiece model 40M and can make an adjustment in such a way as to cause tool model 30M to come in contact with workpiece model 40M over a wider area, which enables efficient machining. The function of adjusting the position and posture of a teaching point by teaching point position-posture adjustment unit 115 will be described below with reference to FIG. 10A, FIG. 10B, and FIG. 11 to FIG. 14.

As illustrated in FIG. 10A, contact region specification unit 111 accepts specification of a contact region with workpiece model 40M on tool model 30M. For example, when tool model 30M is a disk-shaped grinder as illustrated in FIG. 10A, a circular region in the central part of bottom face 31 is specified as contact region A1. Contact region specification unit 111 may provide a graphical user interface for accepting an operation of specifying a contact region on tool model 30M by a graphical operation.

Teaching point position-posture adjustment unit 115 has a function of, when contact region Al is specified for tool model 30M through contact region specification unit 111, adjusting the position and posture of a teaching point in the robot program in such a way that the specified contact region is always in contact with workpiece model 40M during work. For example, teaching point position-posture adjustment unit 115 causes contact region A1 to be always in contact with workpiece model 40M by adjusting the position and posture of tool model 30M in a direction of translation and a direction of rotation. FIG. 10B illustrates, as an example, a situation where the position and posture of tool model 30M are adjusted by teaching point position-posture adjustment unit 115 in directions of translation Tz and Ty and a direction of rotation Rx. The direction of translation Tz is a direction along center line C1 of tool model 30M, and the direction of translation Ty is a direction perpendicular to the direction of translation Tz. The direction of rotation Rz represents a direction of rotation around an axis perpendicular to the directions of translation Tz and Ty with respect to the center position of the bottom face of tool model 30M.

Maximum penetration depth specification unit 112 accepts specification of a maximum penetration depth specifying a depth of machining surface 41 of workpiece model 40M down to which tool model 30M is allowed to penetrate. The maximum penetration depth can be defined as a depth D from machining surface 41, as illustrated in FIG. 11. Accordingly, in this case, tool model 30M is allowed to penetrate down to virtual surface 41a at the depth D from machining surface 41. The “maximum penetration depth” corresponds to an allowable value defining the degree to which tool model 30M is allowed to penetrate workpiece model 40M. Maximum penetration depth specification unit 112 functions as a penetration depth specification unit accepting input of the allowable value.

When the maximum penetration depth is specified, teaching point position-posture adjustment unit 115 makes an adjustment by translating or rotating tool model 30M in such a way that tool model 30M is always in contact with workpiece model 40M at the maximum penetration depth or less. FIG. 11 illustrates a situation where teaching point position-posture adjustment unit 115 adjusts the position and posture of tool model 30M in the directions of translation Tz and Ty and the direction of rotation Rx.

Teaching point position-posture adjustment unit 115 has a function of adjusting the position and posture of a teaching point in the robot program in such a way as to maximize the contact area between tool model 30M and workpiece model 40M. Teaching point position-posture adjustment unit 115 can make an adjustment in such a way as to maximize the contact area between tool model 30M and workpiece model 40M by translating or rotating tool model 30M relative to workpiece model 40M, as illustrated in FIG. 12. FIG. 12 illustrates a situation where teaching point position-posture adjustment unit 115 adjusts the position and posture of tool model 30M in the directions of translation Tz and Ty and the direction of rotation Rx in such a way as to maximize the contact area between tool model 30M and workpiece model 40M.

Upper-lower offset amount limit setting unit 113 accepts setting of an upper limit and a lower limit of translation and an upper limit and a lower limit of rotation when the position and posture of a teaching point are adjusted by translating and rotating tool model 30M. When upper and lower limits of an offset amount are set, teaching point position-posture adjustment unit 115 adjusts the position and posture of a teaching point in the robot program in such a way that tool model 30M is always in contact with workpiece model 40M within a range between the upper and lower limits of the offset amount.

FIG. 13 illustrates a situation where, by setting through upper-lower offset amount limit setting unit 113, a range A2 between upper and lower limits is set to an offset amount in the direction of translation Tz, a range A3 between upper and lower limits is set to an offset amount in the direction of translation Ty, and a range A4 between upper and lower limits is set to an offset amount in the direction of rotation Rz. In this case, teaching point position-posture adjustment unit 115 adjusts the position and posture of tool model 30M in such a way that an adjustment range in the direction of translation Tz falls within the range A2, an adjustment range in the direction of translation Ty falls within the range A3, and an adjustment range in the direction of rotation Rx falls within the range A4.

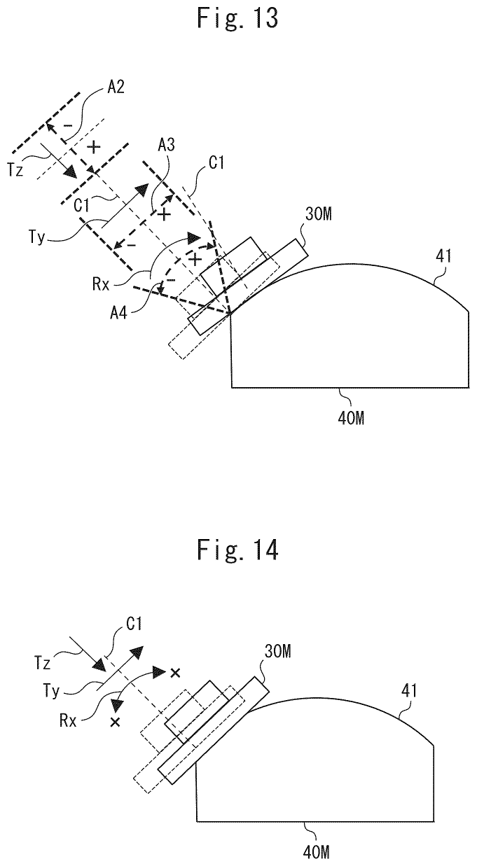

Offset direction restriction specification unit 114 has a function of accepting input of specification of a direction in which an offset is restricted. For example, as illustrated in FIG. 14, an operator can perform, through offset direction restriction specification unit 114, setting for disallowing adjustment in the direction of rotation while allowing adjustment in the directions of translation. In this case, as illustrated in FIG. 14, teaching point position-posture adjustment unit 115 can adjust the position and posture of a teaching point in the robot program in such a way that tool model 30M is always in contact with workpiece model 40M while restricting an offset only to the directions of translation.

Robot program creation unit 116 creates a robot program by reflecting the adjustment of the position and posture as described above made by teaching point position-posture adjustment unit 115 in a teaching point set on the created machining path.

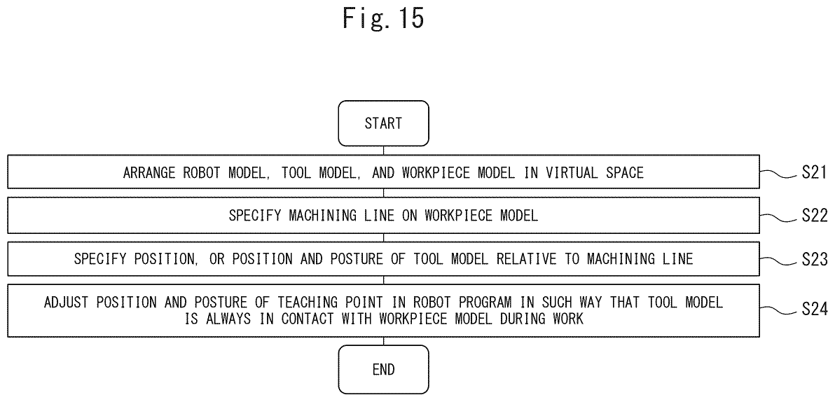

Next, an operation example related to processing for creating a robot program for performing machining in which a tool is positioned to contact a workpiece, such as deburring machining, will be described. In this operation example, robot programming device 10 sets a machining line on a workpiece model and adjusts the position and posture of a tool model along the machining line. FIG. 15 is a flowchart illustrating a flow of robot program creation processing according to this operation example. This processing is executed under the control of processor 11 of robot programming device 10.

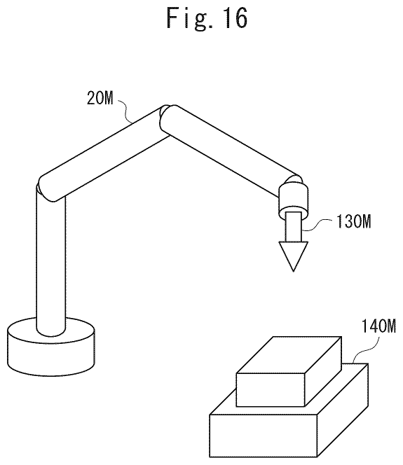

First, virtual space creation unit 101 generates a virtual space on robot programming device 10. Then, three-dimensional model arrangement unit 102 arranges a model of a robot system including a robot model, a tool model, and a workpiece model in the virtual space (step S21). FIG. 16 illustrates a situation where robot model 20M, tool model 130M, and workpiece model 140M are arranged in the virtual space by the processing in step S21. Tool model 130M in this operation example is a model of a deburring tool.

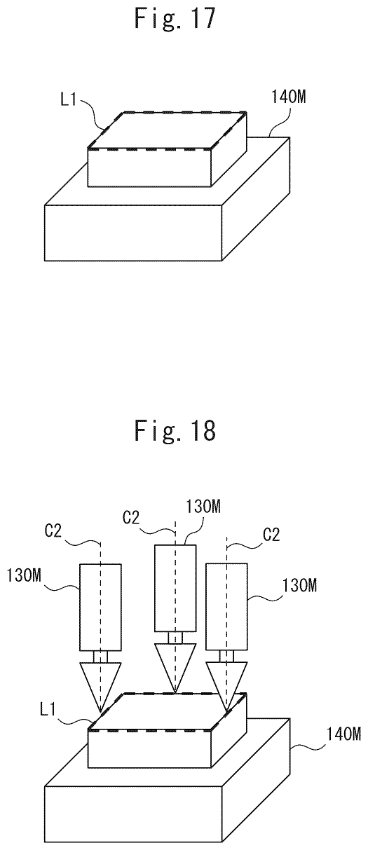

Next, in step S22, machining line specification unit 106 specifies, on workpiece model 140M, a machining line corresponding to a trajectory of moving tool model 130M. Machining line specification unit 106 may have a function of extracting a feature part (a geometric feature such as an outline or a surface) from workpiece model 140M in accordance with a previously specified condition and determining a machining line, based on the extracted feature. The condition in this case may include various conditions for specifying an outline and a surface (e.g., a threshold value of a length and a threshold value of the area of a surface). FIG. 17 illustrates an example of a machining line L1 being specified in an edge line part of a quadrangle on workpiece model 140M.

Next, in step S23, position-posture specification unit 107 sets the position or the position and posture of tool model 130M on specified machining line L1. Position-posture specification unit 107 may accept user input for specifying the position and posture of tool model 130M on the machining line L1. As illustrated in FIG. 18, position-posture specification unit 107 may automatically set the position and posture of tool model 130M in such a way that tool model 130M takes a vertically standing posture at each teaching point on the machining line L1 and the tip part of tool model 130M is positioned at each teaching point.

When the position and posture of tool model 130M on the machining line L1 is thus set, teaching point position-posture adjustment unit 115 adjusts the position and posture of tool model 130M in such a way that tool model 130M is always in contact with workpiece model 140M during work (step S24). The function of adjusting the position and posture of tool model 130M by teaching point position-posture adjustment unit 115 will be described below.

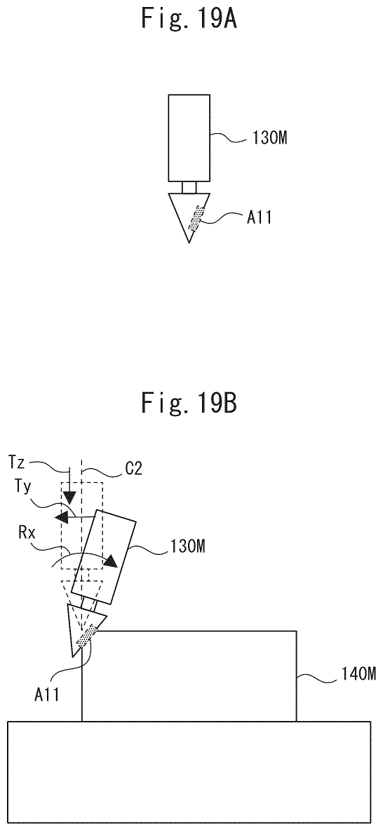

Contact region specification unit 111 accepts specification of a contact region with respect to workpiece model 140M on tool model 130M. For example, when tool model 130M is a deburring tool as illustrated in FIG. 19A, a region on the side of the tool tip part is specified as contact region A11.

Teaching point position-posture adjustment unit 115 has a function of, when contact region A11 is specified on tool model 130M through contact region specification unit 111, adjusting the position and posture of a teaching point in the robot program in such a way that specified contact region A11 is always in contact with workpiece model 140M during work. For example, teaching point position-posture adjustment unit 115 causes contact region A11 to be always in contact with workpiece model 140M by adjusting the position and posture of tool model 130M in directions of translation and a direction of rotation. FIG. 19B illustrates, as an example, a situation in which the position and posture of tool model 130M are adjusted in directions of translation Tz and Ty and a direction of rotation Rx by teaching point position-posture adjustment unit 115 in such a way that contact region A11 is always in contact with workpiece model 140M. The direction of translation Tz is a direction along center line (the rotation axis) C2 of tool model 130M, and the direction of translation Ty is a direction perpendicular to the direction of translation Tz. The direction of rotation Rz represents a direction of rotation around an axis perpendicular to the directions of translation Tz and Ty with respect to the tip of tool model 130M.

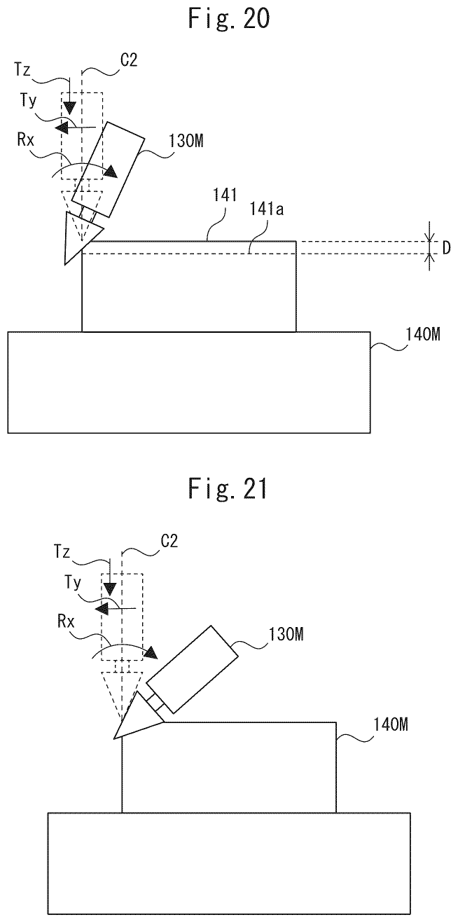

Maximum penetration depth specification unit 112 accepts specification of a maximum penetration depth specifying a depth of machining surface 141 of workpiece model 140M down to which tool model 130M is allowed to penetrate. The maximum penetration depth can be defined as a depth D from machining surface 141, as illustrated in FIG. 20. Accordingly, in this case, tool model 130M is allowed to penetrate down to virtual surface 141a at the depth D from machining surface 141.

When a maximum penetration depth is specified, teaching point position-posture adjustment unit 115 makes an adjustment by translating or rotating tool model 130M in such a way that tool model 130M is always in contact with workpiece model 140M at the maximum penetration depth or less. FIG. 20 illustrates a situation where teaching point position-posture adjustment unit 115 adjusts the position and posture of tool model 130M in the directions of translation Tz and Ty and the direction of rotation Rx in such a way that tool model 130M is always in contact with workpiece model 140M at the maximum penetration depth or less.

Teaching point position-posture adjustment unit 115 has a function of adjusting the position and posture of a teaching point in the robot program in such a way as to maximize the contact area between tool model 130M and workpiece model 140M. Teaching point position-posture adjustment unit 115 can make an adjustment in such a way as to maximize the contact area between tool model 130M and workpiece model 140M by translating or rotating tool model 130M relative to workpiece model 140M, as illustrated in FIG. 21. FIG. 21 illustrates a situation where teaching point position-posture adjustment unit 115 adjusts the position and posture of tool model 130M in the directions of translation Tz and Ty and the direction of rotation Rx in such a way as to maximize the contact area between tool model 130M and workpiece model 140M.

Upper-lower offset amount limit setting unit 113 accepts setting of an upper limit and a lower limit of translation and an upper limit and a lower limit of rotation when the position and posture of a teaching point are adjusted by translating and rotating tool model 130M. When upper and lower limits of an offset amount is set, teaching point position-posture adjustment unit 115 adjusts the position and posture of a teaching point in the robot program in such a way that tool model 130M is always in contact with workpiece model 140M within a range between the upper and lower limits of the offset amount.

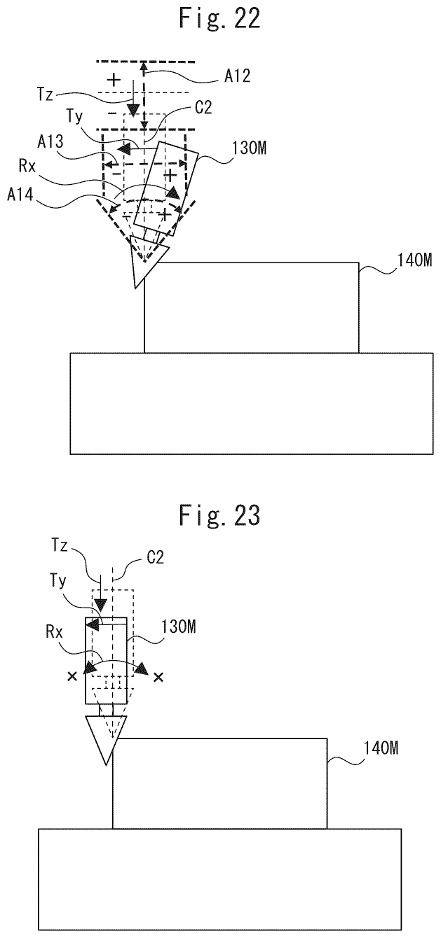

FIG. 22 illustrates a situation where, by setting through upper-lower offset amount limit setting unit 113, a range A12 between upper and lower limits is set to an offset amount in the direction of translation Tz, a range A13 between upper and lower limits is set to an offset amount in the direction of translation Ty, and a range A14 between upper and lower limits is set to an offset amount in the direction of rotation Rz. In this case, teaching point position-posture adjustment unit 115 adjusts the position and posture of tool model 130M in such a way that an adjustment range in the direction of translation Tz falls within the range A12, an adjustment range in the direction of translation Ty falls within the range A13, and an adjustment range in the direction of rotation Rx falls within the range A14.

Offset direction restriction specification unit 114 has a function of accepting input of specification of a direction in which an offset is restricted. For example, as illustrated in FIG. 23, an operator can perform, through offset direction restriction specification unit 114, setting for disallowing adjustment in the direction of rotation while allowing adjustment in the directions of translation. In this case, as illustrated in FIG. 23, teaching point position-posture adjustment unit 115 can adjust the position and posture of a teaching point in the robot program in such a way that tool model 130M is always in contact with workpiece model 140M while restricting the offset only to the directions of translation.

As described above, teaching point position-posture adjustment unit 115 has the following functions as functions for optimizing the contact state between a tool model and a workpiece model.
(F1) A function of, when the tool model is specified with a contact region with respect to the workpiece model through contact region specification unit 111, adjusting the position and posture of the tool model in such a way that the specified contact region is always in contact with the workpiece model.
(F2) A function of, when a maximum penetration depth is specified through maximum penetration depth specification unit 112, adjusting the position and posture of the tool model in such a way that the tool model is always in contact with the workpiece model at the maximum penetration depth or less.
(F3) A function of adjusting the position and posture of the tool model in such a way that the tool model is always in contact with the workpiece model and the contact area between the tool model and the workpiece model is maximized.
(F4) A function of, when upper and lower limits of an offset amount is specified through upper-lower offset amount limit setting unit 113, adjusting the position and posture of the tool model in such a way that the tool model is always in contact with the workpiece model within a range between the upper and lower limits of the offset amount.
(F5) A function of, when an offset direction is restricted through offset direction restriction specification unit 114, adjusting the position and posture of the tool model in such a way that the tool model is always in contact with the workpiece model without adding an offset in the restricted offset direction.

The function (F1) enables specification of a contact region for performing proper machining from various viewpoints such as performance of the tool and the posture of the tool relative to the workpiece.

The function (F2) enables proper machining by preventing the tool from excessively shaving the workpiece by biting. Prevention of excessive shaving of the workpiece is highly important in terms of machining quality, and performing machining in such a way as to enable prevention of excessive shaving of the workpiece is also advantageous in terms of a machining time.

The function (F3) enables maximization of the contact area between the tool and the workpiece in machining and efficient machining at a proper tool posture based on the maximization of the contact area.

The function (F4) enables adjustment with an adjustment range of the position or the position and posture of the tool being restricted to a desired range.

The function (F5) enables adjustment of the position and posture of the tool model while restricting addition of an offset in a specific direction.

Teaching point position-posture adjustment unit 115 may have two or more functions of the aforementioned functions (F1) to (F5). For example, teaching point position-posture adjustment unit 115 may have the aforementioned functions (F2) and (F3). In this case, the tool can efficiently perform machining by coming in contact with the workpiece in a wider area while preventing excessive shaving of the workpiece by biting.

As described above, according to the present embodiment, adjustment for optimizing the position and posture of a tool model relative to a workpiece model can be automated in teaching using the robot programming device. According to the present embodiment, efficient adjustment work for the position and posture of a teaching point can be performed without requiring technical knowledge on the part of an operator. In other words, according to the present embodiment, time and effort of an operator in adjustment work for the position and posture of a teaching point can be reduced.

The function as the robot programming device described above may be included in a teaching device or a controller of a robot.

The functional blocks in the robot programming device illustrated in FIG. 2 may be provided by one or a plurality of processors in the robot programming device executing various types of software stored in a storage device or may be provided by a configuration mainly based on hardware such as an application specific integrated circuit (ASIC).

A program executing the robot program creation processing according to the embodiment described above, the processing being illustrated in FIG. 3 and FIG. 15, can be recorded on various computer-readable storage media (e.g., semiconductor memories such as a ROM, an EEPROM, and a flash memory; a magnetic storage medium; and optical disks such as a CD-ROM and a DVD-ROM).

While the present disclosure has been described in detail, the present disclosure is not limited to each of the aforementioned embodiments. Various additions, substitutions, changes, partial deletions, and the like may be made to the embodiments without departing from the spirit of the present disclosure or without departing from the scope of the present disclosure derived from the contents described in the claims and the equivalents thereof. Further, the embodiments may be implemented in combination. For example, an operation order or a processing order is described as an example in the aforementioned embodiments and is not limited thereto. Further, the above also holds when a numerical value or a mathematical expression is used in the description of the aforementioned embodiments.

The following supplementary notes are further disclosed with regard to the aforementioned embodiments and the modified examples thereof.

### Supplementary Note 1

A robot programming device (10) including: a three-dimensional model arrangement unit (102) configured to arrange a robot model, a tool model, and a workpiece model in a virtual space; a penetration depth specification unit (112) configured to accept specification of an allowable value of a penetration depth of the tool model relative to the workpiece model; and a teaching point position-posture adjustment unit (115) configured to adjust a position and posture of the tool model at a teaching point in a robot program in such a way that the tool model comes into contact with the workpiece model in a state of the penetration depth of the tool model relative to the workpiece model being equal to or less than the allowable value.

### Supplementary Note 2

The robot programming device (10) according to Supplementary Note 1, wherein the teaching point position-posture adjustment unit (115) is configured to adjust a position and posture of the tool model at a teaching point in such a way that the penetration depth of the tool model relative to the workpiece model is equal to or less than the allowable value, a contact area between the tool model and the workpiece model is maximized, and the tool model is always in contact with the workpiece model.

### Supplementary Note 3

The robot programming device (10) according to Supplementary Note 1 or 2, further including a contact region specification unit (111) configured to accept input for specifying, on the tool model, a contact region with respect to the workpiece model, wherein the teaching point position-posture adjustment unit (115) is configured to adjust the position and posture of the tool model at a teaching point in the robot program in such a way that the contact region of the tool model is always in contact with the workpiece model.

### Supplementary Note 4

The robot programming device (10) according to any one of Supplementary Notes 1 to 3, further including an upper-lower offset amount limit setting unit (113) configured to accept input for specifying upper and lower limits of an offset amount when the position and posture of the tool model at a teaching point in the robot program is adjusted, wherein the teaching point position-posture adjustment unit (115) is configured to adjust the position and posture of the tool model at a teaching point in the robot program in such a way that the tool model is always in contact with the workpiece model within a range between the set upper and lower limits of the offset amount.

### Supplementary Note 5

The robot programming device (10) according to any one of Supplementary Notes 1 to 4, further including an offset direction restriction specification unit (114) configured to accept input for restricting a direction in which an offset amount is added when the position and posture of the tool model at a teaching point in the robot program is adjusted, wherein the teaching point position-posture adjustment unit (115) is configured to adjust the position and posture of the tool model at a teaching point in the robot program in such a way that an offset amount is not added in a restricted direction and the tool model is always in contact with the workpiece model.

### Supplementary Note 6

The robot programming device (10) according to any one of Supplementary Notes 1 to 5, further including: a three-dimensional shape arrangement unit (103) configured to fill a surface of a predetermined three-dimensional shape with a predetermined operation pattern and arranging the predetermined three-dimensional shape in the virtual space in such a way that the predetermined operation pattern is projected on at least one surface of the workpiece model; a machining path creation unit (104) configured to create a machining path of the tool model by projecting the operation pattern on at least one surface of the workpiece model; and a position-posture determination unit (105) configured to determine a position or a position and posture of the tool model, based on the machining path and a normal direction of the at least one surface of the workpiece model, wherein the teaching point position-posture adjustment unit (115) is configured to adjust the position and posture of the tool model determined by the position-posture determination unit (105) at a teaching point set as the machining path.

### Supplementary Note 7

The robot programming device (10) according to any one of Supplementary Notes 1 to 5, further including: a machining line specification unit (106) configured to specify a machining line on the workpiece model; and a position-posture specification unit (107) configured to specify a position or a position and posture of the tool model relative to the machining line, wherein the teaching point position-posture adjustment unit (115) is configured to adjust the position and posture of the tool model specified by the position-posture specification unit at a teaching point set as the machining line.

### Supplementary Note 8

A robot programming method executed on a robot programming device (10), the method including: arranging a robot model, a tool model, and a workpiece model in a virtual space; accepting specification of an allowable value of a penetration depth of the tool model relative to the workpiece model; and adjusting a position and posture of the tool model at a teaching point in a robot program in such a way that the tool model comes into contact with the workpiece model in a state of the penetration depth of the tool model relative to the workpiece model being equal to or less than the allowable value.

### Supplementary Note 9

A program for causing a processor in a computer to execute: a step of arranging a robot model, a tool model, and a workpiece model in a virtual space; a step of accepting specification of an allowable value of a penetration depth of the tool model relative to the workpiece model; and a step of adjusting a position and posture of the tool model at a teaching point in a robot program in such a way that the tool model comes into contact with the workpiece model in a state of the penetration depth of the tool model relative to the workpiece model being equal to or less than the allowable value.

### REFERENCE SIGNS LIST

10 Robot programming device
11 Processor
12 Storage unit
13 Display unit
14 Operation unit
20M Robot model
30M, 130M Tool model
40M, 140M Workpiece model
61, 62, 63, 64 Operation pattern
71, 72 Three-dimensional shape
A1, A11 Contact region
101 Virtual space creation unit
102 Three-dimensional model arrangement unit
103 Three-dimensional shape arrangement unit
104 Machining path creation unit
105 Position-posture determination unit
106 Machining line specification unit
107 Position-posture specification unit
111 Contact region specification unit
112 Maximum penetration depth specification unit
113 Upper-lower offset amount limit setting unit
114 Offset direction restriction specification unit
115 Teaching point position-posture adjustment unit
116 Robot program creation unit

1. A robot programming device comprising:
a three-dimensional model arrangement unit configured to arrange a robot model, a tool model, and a workpiece model in a virtual space;
a penetration depth specification unit configured to accept specification of an allowable value of a penetration depth of the tool model relative to the workpiece model; and
a teaching point position-posture adjustment unit configured to adjust a position and posture of the tool model at a teaching point in a robot program in such a way that the tool model comes into contact with the workpiece model in a state of the penetration depth of the tool model relative to the workpiece model being equal to or less than the allowable value.

2. The robot programming device according to claim 1, wherein
the teaching point position-posture adjustment unit is configured to adjust the position and posture of the tool model at a teaching point in such a way that the penetration depth of the tool model relative to the workpiece model is equal to or less than the allowable value, a contact area between the tool model and the workpiece model is maximized, and the tool model is always in contact with the workpiece model.

3. The robot programming device according to claim 1, further comprising
a contact region specification unit configured to accept input for specifying, on the tool model, a contact region with respect to the workpiece model, wherein
the teaching point position-posture adjustment unit is configured to adjust the position and posture of the tool model at a teaching point in the robot program in such a way that the contact region of the tool model is always in contact with the workpiece model.

4. The robot programming device according to claim 1, further comprising
an upper-lower offset amount limit setting unit configured to accept input for specifying upper and lower limits of an offset amount when the position and posture of the tool model at a teaching point in the robot program are adjusted, wherein
the teaching point position-posture adjustment unit is configured to adjust the position and posture of the tool model at a teaching point in the robot program in such a way that the tool model is always in contact with the workpiece model within a range between the set upper and lower limits of the offset amount.

5. The robot programming device according to claim 1, further comprising
an offset direction restriction specification unit configured to accept input for restricting a direction in which an offset amount is added when the position and posture of the tool model at a teaching point in the robot program are adjusted, wherein
the teaching point position-posture adjustment unit is configured to adjust the position and posture of the tool model at a teaching point in the robot program in such a way that an offset amount is not added in a restricted direction and the tool model is always in contact with the workpiece model.

6. The robot programming device according to claim 1, further comprising:
a three-dimensional shape arrangement unit configured to fill a surface of a predetermined three-dimensional shape with a predetermined operation pattern and arranging the predetermined three-dimensional shape in the virtual space in such a way that the predetermined operation pattern is projected on at least one surface of the workpiece model;
a machining path creation unit configured to create a machining path of the tool model by projecting the operation pattern on at least one surface of the workpiece model; and
a position-posture determination unit configured to determine a position or a position and posture of the tool model, based on the machining path and a normal direction of the at least one surface of the workpiece model, wherein
the teaching point position-posture adjustment unit is configured to adjust the position and posture of the tool model determined by the position-posture determination unit at a teaching point set as the machining path.

7. The robot programming device according to claim further comprising:
a machining line specification unit configured to specify a machining line on the workpiece model; and
a position-posture specification unit configured to specify a position or a position and posture of the tool model relative to the machining line, wherein
the teaching point position-posture adjustment unit is configured to adjust the position and posture of the tool model specified by the position-posture specification unit at a teaching point set as the machining line.

8. A robot programming method executed on a robot programming device, the method comprising:
arranging a robot model, a tool model, and a workpiece model in a virtual space;
accepting specification of an allowable value of a penetration depth of the tool model relative to the workpiece model; and
adjusting a position and posture of the tool model at a teaching point in a robot program in such a way that the tool model comes into contact with the workpiece model in a state of the penetration depth of the tool model relative to the workpiece model being equal to or less than the allowable value.

9. A non-transitory computer readable storage medium storing instructions that, when executed by a processor of a computer, cause the processor to perform:
arranging a robot model, a tool model, and a workpiece model in a virtual space;
accepting specification of an allowable value of a penetration depth of the tool model relative to the workpiece model; and
adjusting a position and posture of the tool model at a teaching point in a robot program in such a way that the tool model comes into contact with the workpiece model in a state of the penetration depth of the tool model relative to the workpiece model being equal to or less than the allowable value.
